(19) United States
(12) Patent Application Publication
(10) Pub. No.: US 2013/0156907 A1
(43) Pub. Date: Jun. 20, 2013

(54) PROCESS FOR SANITIZING OBJECTS

(71) Applicant: Robert Larose, Barkhamsted, CT (US)

(72) Inventor: Robert Larose, Barkhamsted, CT (US)

(73) Assignee: BIOSAFE SYSTEMS LLC, East Hartford, CT (US)

(21) Appl. No.: 13/817,114

(22) PCT Filed: Aug. 22, 2011
(86) PCT No.: PCT/US11/48587

§ 371 Date: Feb. 14, 2013

Related U.S. Application Data
(60) Provisional application No. 61/375,930, filed on Aug. 23, 2010.

(51) Int. Cl. A23B 7/144; A23B 9/18

(52) U.S. Cl. CPC A23B 7/144; A23B 9/18
USPC 426/248; 426/320; 426/318; 426/319

(57) ABSTRACT

A process for sanitizing objects is comprised of the steps of: (1) contacting the object with a dry fog in an enclosed sanitization zone wherein the dry fog is comprised of droplets having a diameter of 4-5 microns and wherein the droplets comprise an aqueous solution of a sanitizing agent for a time sufficient to produce a substantially dry sanitized object and a residual amount of dry fog; (2) removing the substantially dry, sanitized product from the enclosed zone while simultaneously removing the residual dry fog and passing the residual dry fog through a treatment zone whereby unreacted sanitizing agent is removed from the dry fog. The disclosed process yields substantially dry sanitized objects that do not require rinsing with water.

### CROSS-REFERENCE TO RELATED APPLICATIONS

This application claims the benefit of International Application No. PCT/US2011/048587, filed on Aug. 22, 2011, which application claims the benefit of U.S. Provisional Application Ser. No. 61/375,930, filed on Aug. 23, 2010. The entire contents of both applications are incorporated herein by reference.

### BACKGROUND OF THE INVENTION

### Field of the Invention

The present invention pertains to an improved process for sanitizing an object such as produce. Typical processing methods for sanitizing such objects as fruits and vegetables prior to their introduction to the market involve feeding such items on a conveyer belt past a spray nozzle, which emits a fine mist of an aqueous solution of a sanitizing agent. The amount of sanitizing agent that contacts the object is a function of the speed of the conveyer belt and the size of the droplets of the aqueous sanitizing solution. The treated products normally have an unacceptably high amount of residual surface moisture, which can affect their shelf life.

The conventional process is typically carried out in the open within a treatment area in a building. As a result of the open air treatment, workers operating the treatment equipment are exposed to the sanitizing spray for long periods of time thereby exposing them to potential health and safety risks. In addition, the treatment equipment is also at risk of possible corrosion because of exposure to the sanitizing spray mist, which can contain corrosive substances such as chlorine or peracetic acid.

### BRIEF SUMMARY OF THE INVENTION.

The present invention overcomes the above disadvantages by employing a process for sanitizing objects comprising the steps of: (1) contacting the object with a dry fog in an enclosed sanitization zone wherein the dry fog is comprised of droplets having a diameter of 4-5 microns and wherein the droplets comprise an aqueous solution of a sanitizing agent for a time sufficient to produce a substantially dry sanitized object and a residual amount of dry fog; (2) removing the substantially dry, sanitized product from the enclosed zone while simultaneously removing the residual dry fog and passing the residual dry fog through a treatment zone whereby unreacted sanitizing agent is removed from the dry fog. The process according to the invention yields substantially dry, sanitized objects that do not require rinsing with water.

### BRIEF DESCRIPTION OF THE DRAWING

FIG. 1 shows a block diagram of a preferred embodiment according to the invention. The sanitizing agent solution is fed from the reservoir I into a spray controller D by an injector fan B. Compressed air, C, is also fed into the spray controller, which then feeds the mixture of air and sanitizing agent into one or more spray nozzles, which is/are located inside sanitization zone A. The objects to be sanitized are moved into and out of sanitization zone A by means of a conveyer belt G. Re-circulating fan F pulls air-dry fog mixture from the exit end of sanitization zone A and feeds it through a deactivation zone containing a compound such as solid sodium bicarbonate particles and then into the entrance end of sanitization zone A.

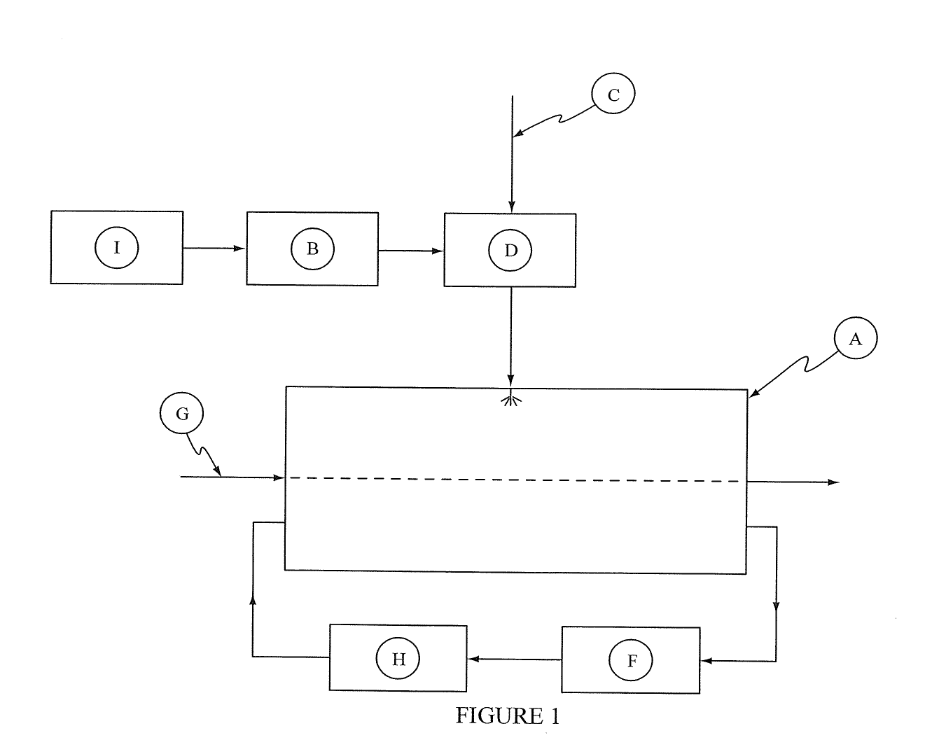

### DETAILED DESCRIPTION OF THE INVENTION

The present invention pertains to an improved process for sanitizing objects. Such objects can be any objects in need of sanitizing. The term “sanitizing” as it is used herein refers to disinfecting and/or cleansing the surface of an object by removing or killing pathogenic microorganisms. It is well known that pathogenic microorganisms are those that cause disease and include bacteria, mold, and fungus The sanitizing agent can be anything that will remove or kill bacteria, mold and/or fungus that is/are present on the surface of the object(s) to be sanitized, such as chlorine, quaternary ammonium compounds, hydrogen peroxide, and peroxycarboxylic acids. The preferred sanitizing agent is a mixture of peracetic acid and hydrogen peroxide. Preferably, the process according to the invention, also referred to as the Dry Fog process, is utilized for sanitizing produce such as fruits, vegetables, nuts and the like. In this process, the sanitization takes place in a treatment zone, which is a chamber that can be a box-like or tent-like structure that covers the dry fog spray area, thereby preventing exposure of humans and equipment to the dry fog. For example, when the Dry Fog process according to the invention is used to sanitize produce, the enclosure is preferably a stainless steel box-like structure mounted over a moving belt that carries the produce into and out of the enclosure through openings in opposite walls of the enclosure. The enclosure, on its interior surfaces, is provided with one or more spray nozzles from which the dry fog is emitted. The enclosure can also be formed from flexible material such as a plastic film draped over a sanitizing treatment area resulting in a tent-like structure. The enclosure can also be a combination of a box-like structure and a tent-like structure.

The dry fog spray is continuously removed from the sanitization zone by any means that can move the air/dry fog mixture, such as a fan or equivalent means. The removal of the air/dry fog mixture in this manner also prevents leakage of the air/dry fog mixture from the sanitization zone into the surrounding atmosphere. The air/dry fog mixture that exits the sanitization zone is then passed through a deactivation zone, which removes and/or inactivates the sanitizing agent. For example, when the sanitizing agent is peracetic acid, the air-sanitizing fog mixture is passed through solid sodium bicarbonate particles, for example in the form of tablets, which decomposes the peracetic to acetic acid, oxygen and water.

The process according to the invention can also be used in conjunction with Ultra Violet (UV) radiation when hydrogen peroxide and/or a peroxycarboxylic acid are used as the sanitizing agent. More specifically, one or more UV light sources can be placed within the sanitization zone in order to enhance the killing effect of the hydrogen peroxide and/or a peroxycarboxylic acid on the pathogenic microorganisms. This enhancement results from the ability of UV radiation alone to function as an effective disinfectant for a variety of microorganisms in addition to activating the peroxide for reaction with organic substances. As a result of the increased microbial kill efficiency, shorter contact times through the Dry Fog unit are possible. One consequence of the shorter contact times is that shorter sanitization zone lengths can be utilized. This, in turn, allows a more compact apparatus for use in instances where space is at a premium.

Because the droplets which make up the fog are relatively small, 4-5 microns in diameter, the fog spray is substantially dry. The dry fog yields treated objects such as fruits and vegetables that are substantially dry after sanitization.

The amount of sanitizing agent used in the process according to the invention can be from about 0.5 oz. to about 5 oz. per hour. The preferred amount is from about 0.5 oz. to about 1.0 oz. per hour. The conveyer speed and the amount of dry fog fed into the sanitizing zone are adjusted so that the desired contact time with the objects to be sanitized is achieved. When the process according to the invention is utilized for sanitizing produce the contact time will typically vary from about 10 seconds to about 30 seconds for most fruits and vegetables such as tomatoes, strawberries, blueberries and the like.

### EXAMPLE 1

### Evaluation of Dry Spray Treatment of Blueberries

The effectiveness of the Dry Fog process in removing mold and yeast on blueberries was determined during a 21-day trial. In the Dry Fog process, Blueberries were exposed to 4% and 10% StarOx® Broad Spectrum Bactericide/Fungicide, a trademark product of BioSafe Systems, LLC, which is an aqueous solution of peracetic acid and hydrogen peroxide, at a 10-second and 20-second high density dry fog exposure. The Standard Plate Count (SPC) method was used to determine the presence of non-specific (genus/species) mold and yeast in the samples. Each 2-cup sample was randomly selected and submitted to Bodycote Testing Group for quantitative analysis. Bodycote sample was brothed in 0.1% peptone in a 1:10 dilution. It was then plated as a pour plate in up to 10-3 exponent. The media used was potato dextrose agar; the plate was incubated for 5 days at 24 C. StorOx® Broad Spectrum Bactericide/Fungicide was applied to blueberries at various concentrations and time exposures in a high density “dry fog” environment. Secondary testing method, performed by USDA was completed using a buffer agitation method applied to the surface of exposed blueberries and SPC methods. The results are shown in Table 1, below.

TABLE 1
Effectiveness of the Dry Fog Process
In Removing Mold and Yeast on Blueberries.

| | Mold | Yeast |
|---|---|---|
| Sample | (CFU/g) | (CFU/g) |
| Control # 1 | 310 | 20 |
| Control # 2 | 640 | 80 |
| Control # 3 | 380 | 200 |
| 4% (40 ml per liter) StorOx (20 sec) | 40 | 10 |
| 10% (100 ml per liter) StorOx (10 sec) | 110 | <10 |

The results show that the Dry Fog process was effective in reducing mold and yeasts on the berries wherein 4% and 10% solutions of StorOx® sanitizing spray were used. The exposure time and the fog density were key factors determining the efficacy of the product. A 4% solution with an exposure time of 20 seconds performed as well as a 10% solution with an exposure time of 10 seconds.

### EXAMPLE 2

### Evaluation of Dry Spray Treatment for Tomatoes

The effectiveness of the Dry Fog process in removing Botrytis Cinerea (isolate EDG10-05) from tomatoes was determined. Two products were evaluated for efficacy against Botrytis Cinerea (isolate EDG10-05): StorOx® Broad Spectrum Bactericide/Fungicide and KleenGrow™, a trademark product of Pace Chemicals, LTD, which contains a 7.5% aqueous didecyldimethyl ammonium chloride (Table 1). Mature green or red tomatoes on the vine were used that were uniform in size and color, free from wounds and rot and stored at 13° C.155° F. with 70+% RH until treated on Apr. 12, 2010. Tomato clusters were sprayed with B. Cinerea at the rate of 3 mL per cluster using an air-assisted sprayer and allowed to air dry for 4 hours at room temperature. Anthracnose (Colletotrichum coccodes) and other fungal rots (Rhizopus and Penicillium spp.) developed naturally in the fruit. Products were diluted in well water (not chlorinated) and solution temperature)(C°), pH and ORP (Oxidation Reduction Potential) (mV) were recorded for the control (water) and all treatments. Treatments were arranged with three replications (one cardboard box with multiple TOV clusters comprised a replication). Treatments were applied 4 hours after inoculation with B. Cinerea Conidia. The following dry fog system settings were used: Target relative humidity was set up for 100% using the main settings screen, Fog density was set at 20 seconds on, 1 second off, using the main settings screen, Conveyor speed was set to 10 and 30 seconds for different contact time.

Following product or control application in the dry fog tunnel (Table 2), five calyx sections were sampled from each replication, and the quantity of Conidia was determined by dilution plating for day-0 on PDA (Potato Dextrose Agar) and Botrytis selective media. After the treatments on the dry fog, samples were placed in storage at 13° C., 55° F. with 70+% RH for 15 days. Tomatoes were assessed 2, 4, 6, 8, 10 and 15 days after application for incidence of grey mold, anthracnose and other fungal rots. The number of total TOV clusters and total fruit, total number of fruit with Botrytis infection, calyces with Botrytis infection, fruit with anthracnose infection and fruit with other fungal (Rhizopus and Penicillium spp.) infection were recorded. The following scale was used for tomato fruit or calyx infection: 0 (healthy)=0% disease; 1=1-10% disease; 2=11-30% disease; 3=31-70% disease; and 4=71-100% disease. Sporulation of B. Cinerea was quantified by sampling five random fruits with attached calyx per replication. The amount of Bohytis present on tomato calyces and fruit (CFU/g) was calculated as the (number of colonies×dilution factor×volume of dilution)÷weight of sample tissue.

TABLE 2
Treatments and Rates.

| | Treatment | Rate |
|---|---|---|
| 1 | StorOx ® | 1:10 |
| 2 | StorOx ® | 1:25 |
| 3 | StorOx ® | 1:50 |
| 4 | StorOx ® | 1:100 |
| 5 | KleenGrow | 1:5 |
| 6 | KleenGrow | 1:10 |
| 7 | KleenGrow | 1:25 |
| 8 | KleenGrow | 1:50 |
| 9 | KleenGrow | 1:100 |
| 10 | Non-treated control + | Water |
| | B. Cinerea | |
| 11 | Non-treated control − | Water |
| | B. Cinerea | |

### Results.

The results show that the Dry Fog process was effective in removing the Botrytis gray mold was first observed ten days after inoculation and disease incidence increased slightly from day 10 to day 15. All of the StorOx® treatments reduced the incidence and severity of grey mold on calyces and fruit, and populations of B. Cinerea compared to the inoculated, water-treated control. However, the higher rates of StorOx® were more effective in reducing grey mold severity than the lower rates. The efficacy of the two products was statistically similar. However, the high rate (1:5) of KleenGrow™ was phytotoxic to TOV calyces was first observed on tomato fruit eight days after initiation of the experiment and disease incidence increased from Day 8 to Day 15 (Table 4). Inoculation with Botrytis had no effect on anthracnose incidence. Anthracnose disease incidence was suppressed by treatment with the 1:10 and 1:25 rates of StorOx®, and the 1:5 and 1:10 rates of KleenGrow™.

Other fungal rots (caused by Rhizopus and Penicillium spp.) were first observed ten days after experiment initiation and disease incidence increased slightly from Day 10 to Day 15. Other fungal rots (caused by Rhizopus and Penicillium spp.) were first observed ten days after experiment initiation and disease incidence increased slightly from Day 10 to Day 15. Disease incidence was suppressed by treatment with the 1:10, 1:25 and 1:50 rates of StorOx® and the 1:5 and 1:10 rates of KleenGrow™. On average, a contact time of 30 seconds in the dry fog system was significantly more effective in reducing Botrytis disease incidence than 10 seconds contact time. However, there were no differences between contact times in severity of grey mold on calyces or fruit, disease progress or population of B. Cinerea after treatment. There were no statistically significant differences between the 10 and 30 second contact times in incidence of anthracnose and other fungal rots.

Conclusions: Treatment with the 1:10 and 1:25 rates of StorOx® and the 1:5 and 1:10 rates of KleenGrow™ in the dry fog system were consistently effective in reducing incidence of grey mold, anthracnose and other fungal rots on tomatoes. Uniform fog distribution within the dry fog system achieves maximum treatment effectiveness with minimal cost and minimal pathogen contamination.

TABLE 3
Effect of Selected Disinfectants Used in the Dry Fog System
and Contact Times on Incidence and Severity of Botrytis Disease on Tomato.

| | | | Botrytis severity | | Botrytis severity | | Botrytis | |
|---|---|---|---|---|---|---|---|---|
| Source | df | Levels | on calyceszy | | on fruit | | incidence (%) | |
| Treatment | 10 | | P < 0.0001 | F = 15.5 | P < 0.0001 | F = 29.7 | P < .0001 | F = 85.4 |

| | | | | | |
|---|---|---|---|---|---|
| | | StorOx ® (1:10) | 0.2dex | 0.2e | 6.3fg |
| | | StorOx ® (1:25) | 0.4b-e | 0.3de | 13.1d |
| | | StorOx ® (1:50) | 0.8 bc | 0.9cd | 19.5c |
| | | StorOx ® (1:100) | 0.9 b | 2.7b | 26.9b |
| | | KleenGrow ™ (1:5) | 0.1de | 0.2e | 4.6g |
| | | KleenGrow ™ (1:10) | 0.1de | 0.1e | 3.5g |
| | | KleenGrow ™ (1:25) | 0.2cde | 0.3de | 8.6ef |
| | | KleenGrow ™ (1:50) | 0.6bcd | 0.7de | 1.5de |
| | | KleenGrow ™ (1:100) | 0.4b-e | 1.5c | 17.2c |
| | | Non-treated control + | 2.6a | 3.8a | 34.2a |
| | | B. Cinerea | | | |
| | | Non-treated control − | 0.0e | 0.0e | 0.0h |
| | | B. Cinerea | | | |
| Contact | 1 | | P = 0.1155 | P = 0.1557 | P = 0.009 |
| Time | | | F = 7.2 | F = 4.9 | F = 99. |
| | | 10 sec | 0.7a | 1.1a | 14.7a |
| | | 30 sec | 0.4a | 0.8a | 11.7b |
| Treatment X | 10 | | P = 0.0111 | P = 0.2210 | P = 0.101 |
| Contact Time | | | F = 3.3 | F = 1.5 | F = 1.97 |

z Disease ratings and area under the disease progress curves (AUDPC) were based on the severity scale of 0-4, where 0 (healthy) = 0% disease; 1 = 1-10% disease; 2 = 11-30% disease; 3 = 31-70% disease; and 4 = 71-100% disease.
y Severity was calculated according to the formula: Severity = [(category midpoint * number of fruit in category)]/n, where n = total number of fruit/cardboard box.
x Values are the means of three replicate cardboard boxes; treatments followed by the same letter within a column are not significantly different at P0.05.

TABLE 4
Effect of selected disinfectants used in dry fog system and contact times
on AUDPC and population of Botrytis Cinerea (CFU/g) on tomato fruit.

| | | | | | | | Log CFU g −1 | |
|---|---|---|---|---|---|---|---|---|
| | | | | | | | Botrytis | |
| | | | | | Log CFU g −1 | | populations on | |
| | | | | | Botrytis on calyces | | calyces + fruit after | |
| | | | | | after treatment | | application | |
| Source | df | Levels | Botrytis AUDPCZ y | | (Day 0) x | | (Day 15) | |
| Treatment | 10 | | P = 0.0002 | F = 6.5 | P < 0.0001 | F = 857.5 | P < .0001 | F = 42.4 |

| | | | | | |
|---|---|---|---|---|---|
| | | StorOx ® (1:10) | 10.1cde^{w} | 0.9f | 2.4de |
| | | StorOx ® (1:25) | 15.6bcd | 2.6d | 3.1cd |
| | | StorOx ® (1:50) | 24.0b | 3.5b | 4.6b |
| | | StorOx ® (1:100) | 22.8bc | 4.6a | 4.9b |
| | | KleenGrow ™ (1:5) | 5.1de | 0.0g | 1.9e |
| | | KleenGrow ™ (1:10) | 4.6de | 0.0g | 1.9e |
| | | KleenGrow ™ (1:25) | 13.8bcd | 1.1e | 3.3c |
| | | KleenGrow ™ (1:50) | 20.5bc | 3.4bc | 4.2b |
| | | KleenGrow ™ (1:100) | 14.7bcd | 3.2c | 4.5b |
| | | Non-treated control + | 42.8a | 4.8a | 5.8a |
| | | B. Cinerea | | | |
| | | Non-treated control − | 0.0e | 0.0g | 0.0f |
| | | B. Cinerea | | | |
| Contact | 1 | | P = 0.0951 | P = 0.8309 | P = 0.0605 |
| Time | | | F = 9.0 | F = 0.1 | F = 15.4 |
| | | 10 sec | 18.6a | 2.2a | 3.5a |
| | | 30 sec | 13.0a | 2.2a | 3.2a |
| Treatment X | 10 | | P = 0.1913 | P = 0.9992 | P = 0.013 |
| Contact time | | | F = 1.6 | F = 0.1 | F = 3.27 |

z Disease ratings and area under the disease progress curves (AUDPC) were based on the values of the severity scale of 0-4, where 0 (healthy) = 0% disease; 1 = 1-10% disease; 2 = 11-30% disease; 3 = 31-70% disease; and 4 = 71-100% disease.
y Area under the disease progress curve was calculated according to the formula: (M(xi + xi − 1)!2N(ti − ti − 1)) where xi is the severity at each evaluation time and (ti − ti − 1) is the time between evaluations.
x The population of Botrytis present on tomato calyx and fruit (CFU/g) was calculated as number of colonies * dilution factor * volume of dilution * weight of sample tissue.
^{w}Values are the means of three replicate units (XX clusters per box); treatments followed by the same letter within a column are not significantly different at P0.05.

TABLE 5
Effect of Selected Disinfectants Used in Dry Fog System
and Contact Times on Anthracnose Incidence in Tomato.

| | | | Anthracnose | | Anthracnose | |
|---|---|---|---|---|---|---|
| Source | df | Levels | incidence (%)^{z} | | AUDPC^{y} | |
| Treatments1 | 10 | | P0.0031 | F = 4.2 | P = 0.0002 | F = 6.5 |
| | | StorOx ® (1:10) | 33.8ef^{x} | | 38.4cd | |
| | | StorOx ® (1:25) | 32.5f | | 35.6cd | |
| | | StorOx ® (1:50) | 39.6c-f | | 45.1bc | |
| | | StorOx ® (1:100) | 43.3a-e | | 46.3bc | |
| | | KleenGrow ™ (1:5) | 28.4f | | 28.8d | |
| | | KleenGrow ™ (1:10) | 38.1def | | 41.0cd | |
| | | KleenGrow ™ (1:25) | 41.2b-f | | 44.4bc | |
| | | KleenGrow ™ (1:50) | 52.2abc | | 55.4ab | |
| | | KleenGrow ™ (1:100) | 54.5ab | | 57.0ab | |
| | | Non-treated control + | 56.7a | | 66.5a | |
| | | B. Cinerea | | | | |
| | | Non-treated control − | 49.2a-d | | 60.0a | |
| | | B. Cinerea | | | | |
| Contact Time | 1 | | P = 0.1032 | F = 8.2 | P = 0.1058 | F = 7.9 |
| | | 10 sec | 46.7a | | 50.4a | |
| | | 30 sec | 38.7a | | 43.9a | |
| Treatments X | 10 | | P = 0.9488 | F = 0.4 | P = 0.8571 | F = 0.5 |
| Contact Time | | | | | | |

^{z}Disease ratings and area under the disease progress curves (AUDPC) were based on the values of the scale severity of 0-4, where 0 (healthy) = 0% disease; 1 = 1-10% disease; 2 = 11-30% disease; 3 = 31-70% disease; and 4 = 71-100% disease.
^{y}Area under the disease progress curve calculated according to the formula: (M(xi + xi − 1)82N(ti − ti − 1)) where xi is the rating at each evaluation time and (ti − ti − 1) is the time between evaluations.
^{x}Other fungal rots were Rhizopus spp. and Penicillium spp.
w Values are the means of three replicate units (XX clusters per box); treatments followed by the same letter within a column are not significantly different at P0.05.

TABLE 6
Effect of Selected Disinfectants Used in the Dry Fog System and
Contact Times on Rhizopus and Penicillium Rots (Combined) of Tomato.

| | | | Other fungal rots | | Other fungal rots | |
|---|---|---|---|---|---|---|
| Source | df | Levels | incidence (%)^{zx} | | AUDPC^{y} | |
| Treatments¹ | 10 | | P~0.0015 | F = 4.8 | P = 0.0008 | F = 5.3 |
| | | StorOx ® (1:10) | 15.8cde^{w} | | 16.17c-f | |
| | | StorOx ® (1:25) | 7.5e | | 7.58f | |
| | | StorOx ® (1:50) | 13.4de | | 12.00def | |
| | | StorOx ® (1:100) | 21.1 bcd | | 20.17b-e | |
| | | KleenGrow ™ (1:5) | 10.3de | | 10.67def | |
| | | KleenGrow ™ (1:10) | 8.0e | | 8.33ef | |
| | | KleenGrow ™ (1:25) | 17.7cde | | 17.83c-f | |
| | | KleenGrow ™ (1:50) | 21.4bcd | | 21.58bcd | |
| | | KleenGrow ™ (1:100) | 32.2ab | | 31.58ab | |
| | | Non-treated control + | 26.5abc | | 26.67abc | |
| | | B. Cinerea | | | | |
| | | Non-treated control − | 36.10a | | 37.25a | |
| | | B. Cinerea | | | | |
| Contact Time | 1 | | P = 0.3815 | F = 1.2 | P = 0.3725 | F = 1.3 |
| | | 10 sec | 21.2a | | 21.1a | |
| | | 30 sec | 16.9a | | 17.0a | |
| Treatments X contact | 10 | | P = 0.8289 | F = 0.6 | P = 0.8038 | F = 0.6 |
| time | | | | | | |

^{z}Disease ratings and area under the disease progress curves (AUDPC) were based on the values of the scale severity of 0-4, where 0 (healthy) = 0% disease; 1 = 1-10% disease; 2 = 11-30% disease; 3 = 31-70% disease; and 4 = 71-100% disease.
^{y}Area under the disease progress curve calculated according to the formula: (M(xi + xi − 1)82N(ti − ti − 1)) where xi is the rating at each evaluation time and (ti − ti − 1) is the time between evaluations.
^{x}Other fungal rots were Rhizopus spp. and Penicillium spp.
^{w}Values are the means of three replicate units (one box of tomatoes per unit); treatments followed by the same letter within a column are not significantly different at P0.05.Example 3.

### Evaluation of Dry Spray Treatment of Hazelnuts.

The effectiveness of the Dry Fog process in removing E. coli, Salmonella, mold and yeast on hazelnuts and the appearance of treated hazelnuts was evaluated. The dry fog treatment comprised 85, 200 and 500 PPM of SaniDate® 5.0 Broad Spectrum Bactericide/Fungicide, a trademark product of BioSafe Systems, LLC, which is an aqueous solution of peracetic acid and hydrogen peroxide. Standard methods of microbial analysis were followed to enumerate total aerobic plate count. The test results show that SaniDate® 5.0 when applied in a dry fog process @ 200 PPM of PAA or higher with at least a 30-second contact time significantly improved the microbial quality of hazelnuts. Bleaching and shine of outer skin was also improved significantly at or above 500 PPM treatment level. The data are set forth in Tables 7 and 8 below.

TABLE 7
Microbial Quality of Hazelnuts.

| | Microbial Quality | | | | |
|---|---|---|---|---|---|
| | APC | | Salmonella/ | Mold | Yeasts |
| Treatment | Log CFU/g | E. coli/g | 25 g | CFU/g | CFU/g |
| Untreated | 6.11 | ND | ND | 3200 | 4500 |
| SD 5.0-85 | 5.38 | ND | ND | 500 | 900 |
| PPM PAA | | | | | |
| SD 5.0-200 | 5.05 | ND | ND | <100 | <100 |
| PPM PAA | | | | | |
| SD 5.0-500 | 4.36 | ND | ND | <100 | <100 |
| PPM PAA | | | | | |

ND—Not Detected

TABLE 8
Visual/Sensor Analysis.

| | Bleaching & | | |
|---|---|---|---|
| Treatment | Shine | Smell | Texture |
| Untreated | No | Clear | Solid |
| SaniDate 5.0-85 PPM PAA | Slight | Clear | Solid |
| SaniDate 5.0-200 PPM PAA | Slight | Clear | Solid |
| SaniDate 5.0-500 PPM PAA | Good | Clear | Solid |
| SaniDate 5.0-1000 PPM PAA | Good | Clear | Solid |
| SaniDate 5.0-2000 PPM PAA | Good | Clear | Solid |

### EXAMPLE 4

### Evaluation of Dry Spray Treatment of Tomatoes

The effectiveness of the Dry Fog process in removing and/or controlling the human health pathogen Salmonella enterica serovar Typhimurium on tomatoes was evaluated. Fresh ripe tomatoes were inoculated with S. enterica serovar Typhimurium strain 1A14 (Containing Lux marker gene operon) by adding 10 ml of inoculum to a 1 gal zip-seal bag containing one tomato and gently rotating the bag so that the tomato was completely covered with the inoculum. For non-inoculated tomato samples 10 ml of sterile 1× PBS was added to each bag as described for the inoculated tomato samples. Four replicates, consisting of one fruit per treatment were treated and the experiment was repeated once. StorOx® Broad Spectrum Bactericide/Fungicide was applied to the tomatoes using the Dry Fog system. The Dry Fog parameters (exposure and fog density time) and target microorganisms for each sample type are listed in Table 9.

TABLE 9
Application rates of StorOx and Smart Fog ® System Parameters
(Exposure and Fog Density Time).

| | Application | Exposure | Fog Density | |
|---|---|---|---|---|
| | rate | Time | Time | Target |
| Treatment | % (Dilution) | (Sec) | (Sec) | Microorganism |
| StorOx | 0.4 (1:250) | 20 | 20 | Salmonella |
| | 1.0 (1:100) | 20 | 20 | enterica Serovar |
| | 4.0 (1:25) | 20 | 20 | Typhimurium |
| Water | | 20 | 20 | |
| | | 0 | 0 | |

Tables 10 and 11. Efficacy of StorOx in Reducing Salmonella enterica Serovar Typhimurium on Fresh Tomatoes.

TABLE 10

| | | Mean CFU | | |
|---|---|---|---|---|
| Treatment | Pathogen | per ml | per g tissue | per area (cm²) |
| Non-treated | S. enterica | 6369 | 91 | 77 |
| with fogging | | | | |
| Non-treated | S. enterica | 11250 | 184 | 153 |
| without fogging | | | | |
| 1:250 StorOx | S. enterica | 6 | 0.1 | 0.1 |
| 1:100 StorOx | S. enterica | 0 | 0 | 0 |
| 1:25 StorOx | S. enterica | 0 | 0 | 0 |
| Non-treated | none | 0 | 0 | 0 |
| with fogging | | | | |
| Non-treated | none | 1 | 0 | 0 |
| without fogging | | | | |
| 1:250 StorOx | none | 0 | 0 | 0 |
| 1:100 StorOx | none | 0 | 0 | 0 |
| 1:25 StorOx | none | 0 | 0 | 0 |
| | | p = 0.036 | p = 0.036 | p = 0.036 |

TABLE 11

| | | Mean CFU | | |
|---|---|---|---|---|
| Treatment | Pathogen | per ml | per g tissue | per area (cm²) |
| Non-treated | S. enterica | 5762 | 91 | 75 |
| with fogging | | | | |
| Non-treated | S. enterica | 11875 | 198 | 158 |
| without fogging | | | | |
| 1:250 StorOx | S. enterica | 6 | 0.3 | 0.2 |
| 1:100StorOx | S. enterica | 0.3 | 0.1 | 0.1 |
| 1:25 StorOx | S. enterica | 0.3 | 0 | 0 |
| Non-treated | none | 0 | 0 | 0 |
| with fogging | | | | |
| Non-treated | none | 0.5 | 0 | 0 |
| without fogging | | | | |
| 1:250 StorOx | none | 0.5 | 0 | 0 |
| 1:100 StorOx | none | 0 | 0 | 0 |
| 1:25 StorOx | none | 0 | 0 | 0 |
| | | p = 0.001 | p = 0.001 | p = 0.002 |

In both experiments, the amount of S. enterica Serovar Typhimurium populations was significantly reduced on the surface of fresh processing tomatoes compared to the untreated controls.

### EXAMPLE 5

### Dry Fog Treatment of Radish Mini-Sticks.

The objective of this experiment was the evaluation of the microbial shelf life and sensory characteristics of radish mini-sticks treated by the Dry Fog Process. Radish mini-sticks were spread on a sterile aluminum sheet and passed through the Dry Fog apparatus. The contact time was 20 seconds with 50 and 200 PPM SaniDate® 5.0 as the sanitizing agent. Standard methods of microbial analysis were followed to enumerate total aerobic plate count, mold and yeasts. Appearance, color, odor, texture, flavor and moisture were rated on 1-5 scale and total score for each treatment for each evaluation was calculated. The results are set forth in Tables 12-15.

TABLE 12
Aerobic Plate Count.

| | | | Aerobic Plate Count Log CFU/g | | | |
|---|---|---|---|---|---|---|
| Desig- | | Repli- | DAY- | DAY- | DAY- | DAY- |
| nation | Treatment | cate | 7 | 11 | 13 | 20 |
| 1-1 | Untreated | 1 | 9.01 | 9.47 | 10.04 | 10.04 |
| 1-2 | Untreated | 2 | 8.91 | 9.05 | 9.91 | 10.12 |
| 1-3 | Untreated | 3 | 8.96 | 9.57 | 9.87 | 9.92 |
| Average | | | 8.96 | 9.36 | 9.94 | 10.02 |
| 2-1 | 80 PPM PAA | 1 | 8.37 | 9.33 | 9.75 | 10.06 |
| 2-2 | 80 PPM PAA | 2 | 8.46 | 9.47 | 9.47 | 10.08 |
| 2-3 | 80 PPM PAA | 3 | 8.45 | 9.00 | 8.45 | 10.12 |
| Average | | | 8.42 | 9.27 | 9.22 | 10.09 |
| 3-1 | 200 PPM PAA | 1 | 7.47 | 8.64 | 9.04 | 9.39 |
| 3-2 | 200 PPM PAA | 2 | 7.78 | 8.92 | 8.88 | 9.71 |
| 3-3 | 200 PPM PAA | 3 | 7.91 | 8.75 | 9.05 | 9.73 |
| Average | | | 7.72 | 8.77 | 8.99 | 9.61 |

TABLE 13
Molds.

| | | | Molds | | | |
|---|---|---|---|---|---|---|
| | | | Log CFU/g | | | |
| Designation | Treatment | Replicate | DAY-7 | DAY-11 | DAY-13 | DAY-20 |
| 1-1 | Untreated | 1 | 3.13 | 3.56 | 3.86 | 3.56 |
| 1-2 | Untreated | 2 | 3.26 | 3.73 | 3.50 | 3.73 |
| 1-3 | Untreated | 3 | 2.95 | 3.61 | 3.65 | 3.83 |
| Average | | | 3.11 | 3.63 | 3.67 | 3.71 |
| 2-1 | 80 PPM PAA | 1 | 2.65 | 3.43 | 3.50 | 3.61 |
| 2-2 | 80 PPM PAA | 2 | 2.95 | 3.13 | 3.73 | 3.77 |
| 2-3 | 80 PPM PAA | 3 | 2.65 | 3.35 | 3.50 | 3.56 |
| Average | | | 2.75 | 3.30 | 3.58 | 3.64 |
| 3-1 | 200 PPM PAA | 1 | 2.65 | 3.13 | 3.43 | 3.65 |
| 3-2 | 200 PPM PAA | 2 | 2.65 | 2.65 | 2.95 | 3.43 |
| 3-3 | 200 PPM PAA | 3 | 2.65 | 3.13 | 3.26 | 3.35 |

| | | | | |
|---|---|---|---|---|
| Average | 2.65 | 2.97 | 3.21 | 3.48 |

TABLE 14
Yeasts.

| | | | Yeasts Log CFU/g | | | |
|---|---|---|---|---|---|---|
| Desig- | | Repli- | DAY- | DAY- | DAY- | DAY- |
| nation | Treatment | cate | 7 | 11 | 13 | 20 |
| 1-1 | Untreated | 1 | 5.49 | 5.74 | 6.03 | 6.42 |
| 1-2 | Untreated | 2 | 5.54 | 5.71 | 6.47 | 6.32 |
| 1-3 | Untreated | 3 | 5.61 | 5.47 | 6.14 | 6.64 |
| Average | | | 5.55 | 5.64 | 6.21 | 6.46 |
| 2-1 | 80 PPM PAA | 1 | 4.07 | 4.61 | 4.74 | 5.80 |
| 2-2 | 80 PPM PAA | 2 | 4.20 | 4.70 | 5.16 | 5.74 |
| 2-3 | 80 PPM PAA | 3 | 4.49 | 4.75 | 4.75 | 5.58 |
| Average | | | 4.25 | 4.69 | 4.88 | 5.70 |
| 3-1 | 200 PPM PAA | 1 | 3.73 | 4.58 | 4.75 | 5.08 |
| 3-2 | 200 PPM PAA | 2 | 4.10 | 4.73 | 4.70 | 5.45 |
| 3-3 | 200 PPM PAA | 3 | 3.80 | 4.01 | 4.74 | 5.40 |
| | | | | 4.49 | 4.73 | 5.31 |

TABLE 15
Sensory Analysis.

| | | | Total Score^{a}/30 | | | |
|---|---|---|---|---|---|---|
| Desig- | | Repli- | DAY- | DAY- | DAY- | DAY- |
| nation | Treatment | cate | 7 | 11 | 13 | 20 |
| 1-1 | Untreated | 1 | 24.5 | 23.5 | 25.0 | 21.0 |
| 1-2 | Untreated | 2 | 24.5 | 21.0 | 23.0 | 21.0 |
| 1-3 | Untreated | 3 | 28.0 | 24.5 | 24.0 | 19.0 |
| Average | | | 25.7 | 23.0 | 24.0 | 20.3 |
| 2-1 | 80 PPM PAA | 1 | 29.5 | 25.5 | 25.5 | 23.0 |
| 2-2 | 80 PPM PAA | 2 | 29.5 | 24.5 | 23.0 | 23.0 |
| 2-3 | 80 PPM PAA | 3 | 27.5 | 25.0 | 25.0 | 23.0 |
| Average | | | 28.8 | 25.0 | 24.5 | 23.0 |
| 3-1 | 200 PPM PAA | 1 | 28 | 23.0 | 23.0 | 20.0 |
| 3-2 | 200 PPM PAA | 2 | 28.5 | 25.5 | 25.5 | 20.0 |
| 3-3 | 200 PPM PAA | 3 | 26.5 | 22.5 | 21.5 | 20.0 |
| | | | | 23.7 | 23.3 | 20.0 |

^{a}Average of Two Independent Scorers (Treatments Undisclosed for Scorers)

The invention claimed is:

1. A process for sanitizing an object comprising the steps of: (1) contacting an object with a dry fog in an enclosed sanitization zone for a time sufficient to produce a substantially dry sanitized object and a residual amount of dry fog wherein the dry fog is comprised of droplets having a diameter of 4-5 microns and wherein the droplets comprise an aqueous solution of a sanitizing agent; (2) removing the substantially dry, sanitized product from the enclosed zone while simultaneously removing the residual dry fog and passing the residual dry fog through a treatment zone whereby unreacted sanitizing agent is removed from the dry fog.

2. The process of claim 1 wherein the sanitizing agent is chlorine, quaternary ammonium compounds, hydrogen peroxide, peroxycarboxylic acids or a combination thereof.

3. The process of claim 3 wherein the sanitizing agent is peracetic acid and hydrogen peroxide.

4. The process of claim 1 wherein the sanitizing agent is peracetic acid.

5. The process of claim 1 wherein the object is an article of produce.

6. The process of claim 5 wherein the article of produce is a fruit, a vegetable, a nut or combinations thereof.

7. The process of claim 5 wherein the article of produce is a vegetable.

8. The process of claim 7 wherein the vegetable is a tomato.

9. The process of claim 6 wherein the article of produce is a fruit.

10. The process of claim 8 wherein the fruit is a blueberry, a strawberry or combinations thereof.

11. The process of claim 1 wherein UV radiation is present in the sanitization zone.

12. A process for sanitizing produce comprising the steps of: (1) contacting an item of produce with a dry fog contained in a stainless steel box-like enclosure mounted over a moving belt that carries the produce into and out of the enclosure through openings in opposite walls of the enclosure wherein the produce is contacted for a time sufficient to produce substantially dry sanitized produce and a residual amount of dry fog wherein the dry fog is comprised of droplets having a diameter of 4-5 microns and wherein the droplets comprise an aqueous solution of a sanitizing agent; (2) removing the substantially dry, sanitized produce from the stainless steel enclosure while simultaneously removing the residual dry fog and passing the residual dry fog through a treatment zone whereby unreacted sanitizing agent is removed from the dry fog.

13. The process of claim 12 wherein the sanitizing agent is chlorine, quaternary ammonium compounds, hydrogen peroxide, peroxycarboxylic acids or a combination thereof.

14. The process of claim 13 wherein the sanitizing agent is peracetic acid and hydrogen peroxide.

15. The process of claim 12 wherein the sanitizing agent is peracetic acid.

16. The process of claim 12 wherein the item of produce is a fruit, a vegetable, a nut or combinations thereof.

17. The process of claim 16 wherein the article of produce is a vegetable.

18. The process of claim 17 wherein the vegetable is a tomato.

19. The process of claim 16 wherein the article of produce is a fruit.

20. The process of claim 19 wherein the fruit is a blueberry, a strawberry or combinations thereof.
